(19) United States
(12) Patent Application Publication
(10) Pub. No.: US 2014/0246116 A1
(43) Pub. Date: Sep. 4, 2014

(54) FRACTION COLLECTION APPARATUS

(71) Applicant: GE HEALTHCARE BIO-SCIENCES AB, UPPSALA (SE)

(72) Inventor: Christer Eriksson, Uppsala (SE)

(73) Assignee: GE HEALTHCARE BIO-SCIENCES AB, UPPSALA (SE)

(21) Appl. No.: 14/346,769

(22) PCT Filed: Sep. 27, 2012
(86) PCT No.: PCT/EP2012/069089

§ 371 Date: Mar. 24, 2014

(30) Foreign Application Priority Data
Sep. 30, 2011 (SE) 1100719-2

(51) Int. Cl. B01D 15/24

(52) U.S. Cl. CPC B01D 15/247
USPC 141/1; 141/284

(57) ABSTRACT

The invention relates to a fraction collector apparatus (1; 1′) for positioning at least one fraction collector nozzle (4), comprising a frame (2) arranged for guiding the at least one nozzle (4) to different positions (22) in order to collect and dispense fractions (6) of a substance to or from containers (8). At least one track (10) is arranged in the frame (2), and in which at least one track (10) an endless movable transporting means (12) is arranged; on which transporting means (12) the at least one nozzle (4) is attached; a first actuating means (18) is connected to said transporting means (12) for actuating said transporting means (12) in the track (10), so that said at least one nozzle (4) is movable in different positions (22) along said track (10). The invention also relates to a method of positioning a fraction collector nozzle (4) by means of such a fraction collection apparatus (1; 1′).

### TECHNICAL FIELD

The present invention relates to a fraction collection apparatus, for example, according to the preamble of claim 1. The invention also relates to a method of positioning a fraction collector nozzle by means of such a fraction collection apparatus, for example, according to the preamble of claim 9.

Chromatography is a chemical process for identifying and quantifying components held in a sample of a solution. In the process, the components in the solution are separated from each other as the solution moves through a stationary material held in a column. The solution is pumped under pressure through the stationary material in the column by one or several chromatography pumps. Fractions of the components are collected in a series of individual containers by means of a fraction collection apparatus. In some cases the fractions collected in the individual containers are brought by the fraction collection apparatus and dispensed for further analyzes.

### BACKGROUND ART

A fraction collection apparatus used for receiving fluid from a fractionating column and separating the fractions of the fluid into containers is known. A nozzle for dispensing the fractions into receptacles is arranged on an arm which is movable in two dimensions. Electric motors move the nozzle in a first and second direction, which directions are perpendicular to each others. The motors are controlled by a control system in order to synchronize the motors to move the nozzle to predetermined positions where the fractions should be dispensed.

Such a known fraction collection apparatus includes however a number of components which are complex and expensive. Also, the known apparatus has a dimension which needs considerable space.

Document U.S. Pat. No. 3,871,426 discloses a known fraction collection apparatus for receiving liquid output of a fractionating column and separating the same into chambers or containers. A carriage for a nozzle is movable radially over a rotating disc, which is provided with the chambers for collecting the fractions. The chambers are spaced uniformly along a spiral path. The rotation of the disc and the movement of the nozzle are synchronized, so that each chamber in the disc receives liquid from the fractionating column.

Such rotating disc together with a radially moving nozzle may have a compact construction with small dimensions. The demands on the mechanical components and the complexity are however relatively high, which increase the costs. Also, maintenance costs of such a fraction collection apparatus are high.

### SUMMARY OF THE INVENTION

The object of embodiments of the invention is to achieve a fraction collection apparatus having a simple mechanical construction.

Another object of embodiments of the invention is to achieve a fraction collection apparatus which may be manufactured at a low cost.

A further object of embodiments of the invention is to achieve a fraction collection apparatus with small dimensions.

A further object of embodiments of the invention is to achieve a fraction collection apparatus with high precision.

These objects are addressed by a fraction collection apparatus according to claim 1.

The endless movable transporting means arranged in the track leads to an apparatus having a very simple mechanical construction since the nozzle, attached on the transporting means, will move along a fixed path between the different positions along track. As a result, the apparatus will also have a high precision and be manufactured at a low cost. The first actuating means may be connected to the transporting means in a simple manner and since the transporting means is endless and can be arranged in a compact manner, the overall dimensions of the apparatus will be limited.

According to an aspect of the invention a nozzle holding means is arranged on said transporting means and a tube is connected to said at least one nozzle, so that the tube and the nozzle are detachable from the nozzle holding means. Thereby, the apparatus may be easy to manufacture and also easy to take apart for cleaning purposes.

According to a further aspect of the invention said endless transporting means is a chain, cable, wire or web. This configuration is simple and the apparatus may therefore be manufactured at a low cost.

According to a further aspect of the invention the first actuating means is an electrical step motor, wherein a number of steps of the motor correspond to the distance of consecutive positions of the at least one nozzle along the track. This configuration facilitates to bring the nozzle substantially exactly to predetermined positions. As a result, the fraction collection apparatus will achieve a high precision.

According to a further aspect of the invention a second actuating means is arranged to move the frame in a substantially linear direction, so that the at least one nozzle is movable, in a direction substantially perpendicular to the direction when the at least one nozzle moves along the track. The fraction collection apparatus can hereby collect fractions from containers or receptacles and dispense the fractions to another position for further analysis. Still the overall dimensions of the apparatus will be limited even if the nozzle is arranged to move in a further direction.

According to a further aspect of the invention at least one sensor means is arranged to detect fluid flowing out of the at least one nozzle, and in that said at least one sensor means and said first actuating means are connected to a control unit. The control unit is arranged to control said first actuating means to move the transporting means and the at least one nozzle when no fluid is detected by the sensor means. This sensor means facilitates to bring the nozzle between the predetermined positions without wasting fluid or fractions. As a result, the fraction collection apparatus will achieve a high precision with a minimum of waste and with a minimum of contamination of the fractions.

The above mentioned objects are also achieved by a method of positioning a fraction collector nozzle by means of such a fraction collection apparatus according to claim 9.

### BRIEF DESCRIPTION OF THE DRAWINGS

Further aspects, advantages and features of the invention can be derived from the following detailed description of exemplary embodiments of the invention, with reference to the drawings.

FIG. 1 shows a plan view of a preferred embodiment of a fraction collection apparatus according to the invention,

FIG. 2 shows a cross section view along the line A-A of FIG. 1,

FIG. 3 shows a cross section view along the line B-B of FIG. 1,

FIG. 4 shows a cross section view of a further embodiment of a fraction collection apparatus according to the invention, and

FIG. 5 shows a flowchart of a method of positioning a fraction collector nozzle by means of a fraction collection apparatus according to the invention.

### DETAILED DESCRIPTION

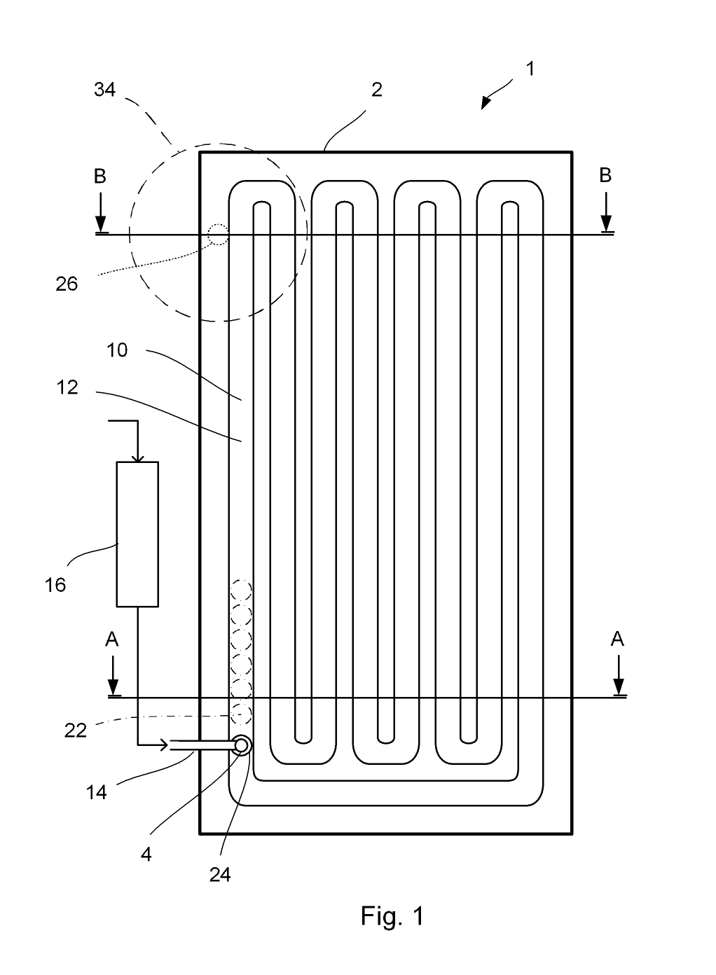

FIG. 1 shows a plan view of a preferred embodiment of a fraction collection apparatus 1 according to the invention. The fraction collector apparatus 1 comprising a frame 2 arranged for guiding the at least one nozzle 4 to different positions in order to collect and dispense fractions 6 of a substance to or from containers 8. A track 10 is arranged in the frame 2 and an endless movable transporting means 12 is arranged in the track 10. The endless transporting means 12 may be a chain, cable, wire or web, such as a rubber band or a band made of plastic. In FIG. 1 the fraction collection apparatus 1 is disclosed from the underside. A tube 14 which in one end is connected to a schematically disclosed chromatography column 16 is in one other end connected to the nozzle 4. The nozzle 4 is attached to the transporting means 12.

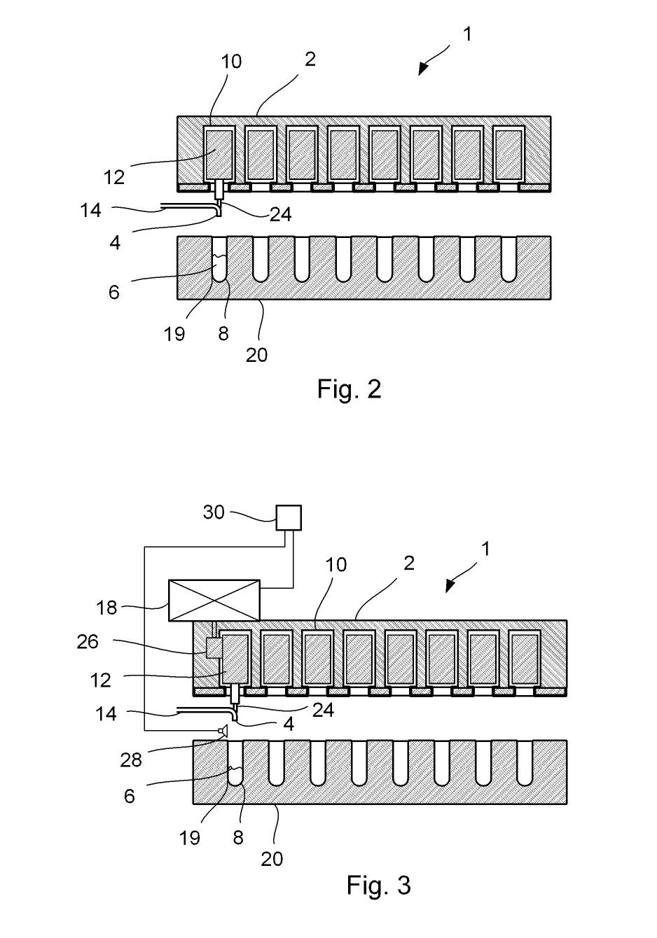

A first actuating means 18 is connected to the transporting means 12 for actuating and moving said transporting means 12 in the track 10. As a result the nozzle 4 is movable in different positions along the track 10. The endless movable transporting means 12 arranged in the track 10 leads to an apparatus 1 having a very simple mechanical construction since the nozzle 4, attached on the transporting means 12, will move along a fixed path between the different positions along the track 10. As a result, the apparatus 1 will also have a high precision and be manufactured at a low cost. The first actuating means 18 is preferably an electrical step motor 18, wherein a number of steps of the motor 18 corresponds to the distance of consecutive positions 22 of the nozzle 4 along the track 10. This configuration facilitates to bring the nozzle 4 substantially exactly to predetermined positions 22 over containers 8, such as receptacles in a rack or cavities 19 in a standard cassette 20, such as a deep well plate, 96-well plate or a microtite plate, which is disclosed in FIG. 2. In FIG. 1 a number of predetermined positions 22 for the nozzle 4 are depicted.

FIG. 2 shows a cross section view along the line A-A of FIG. 1. Preferably, a nozzle holding means 24 is arranged at said transporting means 12, which holds the nozzle 4 and also the tube 14. For cleaning purposes, the tube 14 and the nozzle 4 are detachable from the nozzle holding means 24. The cavities 19 in the cassette 20 are arranged at distances from each others, which correspond to the distances of the track 10 arranged in the frame 2 of the fraction collection apparatus 1. Thus, the track 10 is configured to extend over a matrix of cavities 19 in the cassette 20, which facilitates to bring the nozzle 4 substantially exactly to predetermined positions 22 over the cavities 19 in the cassette 20.

FIG. 3 shows a cross section view along the line B-B of FIG. 1. The first actuating means 18 may be connected to the transporting means 12 by a transmission 26, which may be wheels or rollers depending of type of transporting means 12. A sensor means 28 is arranged to detect fluid flowing out of the nozzle 4. The sensor means 28 and said first electrical motor 18 are connected to a control unit 30, which is arranged to control said first electrical motor 18 to move the transporting means 12 and the nozzle 4 when no fluid is detected by the sensor means 28. The fluid has a slow flow rate in the tube 14 and therefore the fluid drops out of the nozzle 4. Preferably, the sensor means 28 detects and records when no drop leaves the nozzle 4 and at that moment the nozzle 4 is moved to another position. The sensor means 28 facilitates to bring the nozzle 4 between the predetermined positions 22 without wasting the fractions 6 of the fluid.

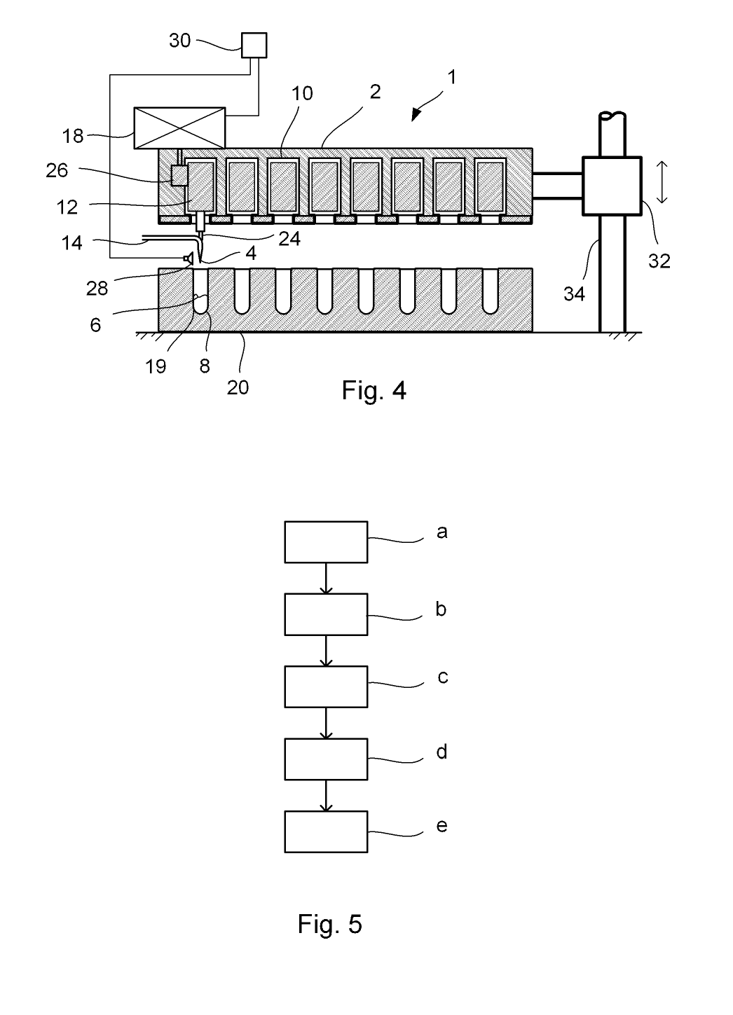

FIG. 4 shows a cross section view of a further embodiment of a fraction collection apparatus 1′ according to the invention. A second actuating means 32 is arranged to move the frame 2, in a substantially linear direction, so that the nozzle 4 is movable, in a direction substantially perpendicular to the direction when the nozzle 4 moves along the track 10. The second actuating means 32 is preferably a linear electrical motor 32 which is connected to the frame 2 of the fraction collection apparatus 1′ and also connected to a substantially vertical fixed bar 34. The fraction collection apparatus 1′ can hereby collect fractions 6 from containers 8 or receptacles and dispense the fractions 6 at another position for further analysis. When the frame 2 and also the nozzle 4 are moved in the direction of the cavities 19 in the cassette 20 arranged under the fraction collection apparatus 1′ the nozzle 4 will reach the fraction 6 in the cavity 19. Then a negative pressure may be applied in the tube 14, so the fraction 6 in the cavity 19 is sucked in the tube 14 through the nozzle 4. The nozzle 4 is thereafter moved in a direction from the cavities 19 in the cassette 20 by means of the second electric motor 32. Finally the nozzle 4 is moved by the first electric motor 18 and the transporting means 12 to a position where the fraction 6 is dispensed from the tube 14 throughout the nozzle 4. Preferably the nozzle 4 is provided with a tip, so that the nozzle 4 can reach the fraction 6 in the cavity 19. Still the overall dimensions of the apparatus 1′ will be limited even if the nozzle 4 is arranged to move in a further direction.

FIG. 5 shows a flowchart of a method of positioning a fraction collector nozzle 4 by means of a fraction collection apparatus 1; 1′ according to the invention. In operation of the fraction collection apparatus 1; 1′, the fraction collector nozzle 4 is positioned by means of the following steps:
a) determining a position 22 where to move the at least one nozzle 4,
b) detecting whether a fluid is flowing out of the nozzle 4,
c) activating the first actuating means 18 if no fluid flowing out of the nozzle 4 is detected,
d) moving the at least one nozzle 4 to the determined position 22, and
e) deactivating said first actuating means 18 when the nozzle 4 has reached the determined position 22.

In the embodiments disclosed above only one nozzle 4 has been disclosed. It is however possible to arrange two or more nozzles 4 at the transporting means 12. It is also possible to arrange two or more tracks 10 in the frame 2 of the fraction collection apparatus 1; 1′.

Features and components of the different embodiments above may be combined within the scope of the invention.

1. A fraction collector apparatus for positioning at least one fraction collector nozzle (4), comprising a frame (2) arranged for guiding the at least one nozzle (4) to different positions (22) in order to collect and dispense fractions (6) of a substance to or from containers (8), wherein at least one track (10) is arranged in the frame (2), and in which at least one track (10) an endless movable transporting means (12) is arranged; on which transporting means (12) the at least one nozzle (4) is attached; a first actuating means (18) is connected to said transporting means (12) for actuating said transporting means (12) in the track (10), so that said at least one nozzle (4) is movable in different positions (22) along said track (10).

2. The apparatus of claim 1, wherein a nozzle holding means (24) arranged on said transporting means (12) and in that a tube (14) is connected to said at least one nozzle (4), so that the tube (14) and the nozzle (4) are detachable from the nozzle holding means (24).

3. The apparatus of claim 1, wherein said endless transporting means (12) is a chain, cable, wire or web.

4. The apparatus of claim 1, wherein said first actuating means (18) is an electrical motor.

5. The apparatus of claim 1, wherein said electrical motor (18) is a step motor, wherein a number of steps of the motor (18) correspond to the distance of consecutive positions (22) of the at least one nozzle (4) along the track (10).

6. The apparatus of claim 1, wherein a transmission (26) is arranged between the first actuating means (18) and the transporting means (12).

7. The apparatus of claim 1, wherein a second actuating means (32) is arranged to move the frame (2) in a substantially linear direction, so that the at least one nozzle (4) is movable in a direction substantially perpendicular to the direction when the at least one nozzle (4) moves along the track (10).

8. The apparatus of claim 1, wherein at least one sensor means (28) is arranged to detect fluid flowing out of the at least one nozzle (4), and in that said at least one sensor means (28) and said first actuating means (18) are connected to a control unit (30); said control unit (30) is arranged to control said first actuating means (18) to move the transporting means (12) and the at least one nozzle (4) when no fluid is detected by the sensor means (28).

9. A method of positioning a fraction collector nozzle (4) by means of the apparatus (1; 1′) of claim 1, comprising the following steps:
a) determining a position (22) where to move the at least one nozzle (4);
b) detecting whether a fluid is flowing out of the nozzle (4);
c) activating the first actuating means (18) if no fluid flowing out of the nozzle (4) is detected;
d) moving the at least one nozzle (4) to the determined position (22); and
e) deactivating said first actuating means (18) when the nozzle (4) has reached the determined position (22).
